(19) United States
(12) Patent Application Publication
(10) Pub. No.: US 2026/0242650 A1
(43) Pub. Date: Aug. 20, 2026

(54) REFRIGERANT COMPOSITION FOR AIR CONDITIONING DEVICE

(71) Applicant: YM LEMY CORPORATION, Daegu (KR)

(72) Inventors: Gum Bae CHOI, Daejeon (KR); Chan Wook PARK, Daegu (KR)

(73) Assignee: YM LEMY CORPORATION, Daegu (KR)

(21) Appl. No.: 19/121,804

(22) PCT Filed: Oct. 24, 2022
(86) PCT No.: PCT/KR2022/016230

§ 371 Date: Apr. 17, 2025

(30) Foreign Application Priority Data
Oct. 19, 2022 (KR) 10-2022-0134651

(51) Int. Cl. C09K 5/04

(52) U.S. Cl. CPC C09K 5/044; C09K 2205/122; C09K 2205/126; C09K 2205/34

(57) ABSTRACT

The present invention relates to a refrigerant composition for an air conditioning device, wherein the refrigerant composition has similar characteristics to those of R410A, has a sufficiently low GWP, and consists of trifluoroethene (R1123) and trifluoroiodomethane (R13I1), and wherein the trifluoroethene (R1123) is in the range of 25 to 35 wt, and the trifluoroiodomethane (R13I1) is in the range of 65 to 75 wt %.

### TECHNICAL FIELD

The present invention relates to a refrigerant composition for an air conditioning device, and more specifically, to a refrigerant composition for an air conditioning device including trifluoroethene and trifluoroiodomethane.

### BACKGROUND ART

Currently, hydrofluorocarbon (HFC)-based refrigerants such as R410A and R134a are widely used as refrigerants for air conditioning devices (hereinafter, referred to as “air conditioning devices”), such as air conditioners. R410A is a binary mixed refrigerant composed of difluoromethane (CH₂F₂; HFC-32 or R32) and pentafluoroethane (C₂HF₅; HFC-125 or R125), is near azeotrope, and is used extensively in commercial and residential system air conditioners for both cooling and heating. Moreover, R410A is known as one of the most consumed refrigerants due to large charge amount required in systems and its high demand.

R134a (CH₂FCF₃), a single-component refrigerant, is widely used in automotive air conditioners and household refrigerators.

However, HFC-based refrigerants are now subject to international regulations due to the Kigali Amendment to the Montreal Protocol, which aims to reduce greenhouse gas emissions, and obligations are imposed according to the reduction quantity and detailed schedule.

The global warming potential (GWP) of R410A is 2,088, and as concerns over global warming rise, R32 with a GWP of 675 is being increasingly used. However, due to A2L (mildly flammable) classification of R32, the use of R32 is limited to small-capacity systems with a refrigerant charge of less than 1.9 kg because of the fire hazard in the event of leakage. Therefore, there is an urgent need for a low-GWP refrigerant that can replace R410A, in high-capacity system air conditioners.

R134a with a GWP of 1, 430 is mainly used in automotive air conditioners. However, in case of passenger vehicles, R1234yf which is a low-GWP refrigerant (GWP=3) is increasingly being adopted globally due to the refrigerant regulation (GWP≤150). Unlike conventional internal combustion engine vehicles, pure electric vehicles which have no heating source lead to a growing application of energy-efficient heat pump systems. However, due to limitations in the physical properties of refrigerants, the heat pump systems fail to meet heating performance requirements in extremely cold conditions. To overcome the above-mentioned problems, electric heaters with high power consumption are added, resulting in reduced driving range during winter, particularly when the outside temperature falls below −10° C.

### DISCLOSURE

### Technical Problem

Accordingly, the present invention has been made in view of the above-mentioned problems occurring in the related art, and it is an objective of the present invention to provide a refrigerant composition which has cooling and heating capabilities capable of replacing R410A, R1234yf, and R134a, has sufficiently low GWP, is non-flammable, is harmless to human bodies and non-toxic (A1 class), exhibits general properties required of refrigerants, and can be used in existing air conditioning devices designed for R410A, R134a, or R1234yf or can be used with minimal or no modification.

It is another objective of the present invention to provide a refrigerant composition, which can be solely used with high efficiency without using expensive high-voltage electric heaters added to address of heating performance lack of R134a used in existing heat pump systems for electric vehicles or R1234yf, environmentally friendly refrigerant, and can meet performance requirements, thereby contributing to the improvement of a winter driving range of electric vehicles.

### Technical Solution

To accomplish the above-mentioned objectives, according to the present invention, there is provided a refrigerant composition for an air conditioning device, including trifluoroethene and trifluoroiodomethane.

In the refrigerant composition, the trifluoroethene is in the range of 25 to 35 wt %, and the trifluoroiodomethane is in the range of 65 to 75 wt %.

In the refrigerant composition, the trifluoroethene is in the range of 25 to 35 wt %, and the trifluoroiodomethane is in the range of 65 to 75 wt %, and a small amount of propane (R290) or R32 is added.

In one embodiment, the trifluoroethene is 30 wt %, and trifluoroiodomethane is 70 wt %.

### Advantageous Effect

The refrigerant composition for an air conditioning device according to the present invention exhibits superior heating performance compared to R1234yf and R134a, has a sufficiently low GWP, is non-flammable and non-toxic (A1 class) according to ASHRAE standards, has zero ozone depletion potential (ODP), is easy to manufacture, and can be substituted with R410A, R1234yf, and R134a through minimal modification in expansion devices and heat exchangers used in air conditioning devices.

Moreover, in applications for electric vehicles, R1234yf is fire-prone due to mild flammability (A2L) in the event of battery overheating. However, trifluoroiodomethane which is one of the mixed refrigerant ingredients of the present invention is non-flammable, may provide additional fire suppression effects, and is particularly advantageous when applied to direct-expansion refrigerant systems for battery cooling.

### BRIEF DESCRIPTION OF DRAWINGS

FIG. 1 is a graph showing saturated vapor pressures according to mixing ratios of trifluoroethene (R1123) and trifluoroiodomethane (R13I1) forming a refrigerant composition for an air conditioning device of the present invention.

FIG. 2 is a graph showing boiling points according to the mixing ratio of trifluoroethene (R1123) and trifluoroiodomethane (R13I1) forming the refrigerant composition for an air conditioning device of the present invention.

FIG. 3 is a graph showing volumetric capacities at 0° C. according to the mixing ratio of trifluoroethene (R1123) and trifluoroiodomethane (R13I1) forming the refrigerant composition for an air conditioning device of the present invention.

FIG. 4 is a graph showing volumetric capacities at −30° C. according to the mixing ratio of trifluoroethene (R1123) and trifluoroiodomethane (R13I1) forming the refrigerant composition for an air conditioning device of the present invention.

FIG. 5 is a graph showing combustion heat values according to the mixing ratio of trifluoroethene (R1123) and trifluoroiodomethane (R13I1) forming the refrigerant composition for an air conditioning device of the present invention.

FIG. 6 is an example of an air conditioning device tested with the refrigerant composition for the air conditioning device according to the present invention.

### MODE FOR INVENTION

Unless otherwise defined, all technical and scientific terms used in the description of the present invention have meanings commonly understood by those skilled in the art to which the present disclosure belongs. All terms used in the present disclosure are selected to clearly describe the present invention and are not intended to limit the scope of rights according to the present disclosure.

Expressions such as “comprising”, “including”, or “having” used in the description of the present invention should be interpreted as open-ended terms that imply the possibility of including other embodiments unless otherwise specified.

Singular expressions used in the description of the present invention may include plural meanings unless otherwise specified, and the same interpretation applies to the claims.

Terms such as “first”, “second”, etc., used in the description of the present invention are used to distinguish between multiple components and do not limit the order or importance of the components.

When a component is described as being “connected” or “coupled” to another component in the description of the present invention, it should be understood to include both a direct connection or coupling and an indirect connection or coupling via other new components.

### DEFINITION OF TERMS

In the present specification, when used in the context of “replacing” a first refrigerant with a second refrigerant, as a first type, the term “replacement” refers to allowing operation under optimal conditions using the second refrigerant in a device designed to operate using the first refrigerant through only minor modifications or adjustments to some parts (such as refrigerating machine oil, gasket, packing, expansion valve, dryer, or at least one other component) as occasion demands. That is, such a type of “replacement” refers to operating the same device with a different refrigerant.

Forms of such replacement include “drop-in replacement”, “nearly drop-in replacement”, and “retrofit” in increasing order of required modification or adjustment when replacing with the second refrigerant.

As a second type, the term “replacement” refers to using the second refrigerant in a device designed to operate with the second refrigerant for the same purpose as the first refrigerant. Such a type refers to offering the refrigerant for the same use as the previous refrigerant.

Hereinafter, with reference to the accompanying drawings, a refrigerant composition for an air conditioning device according to the present invention will be described in detail.

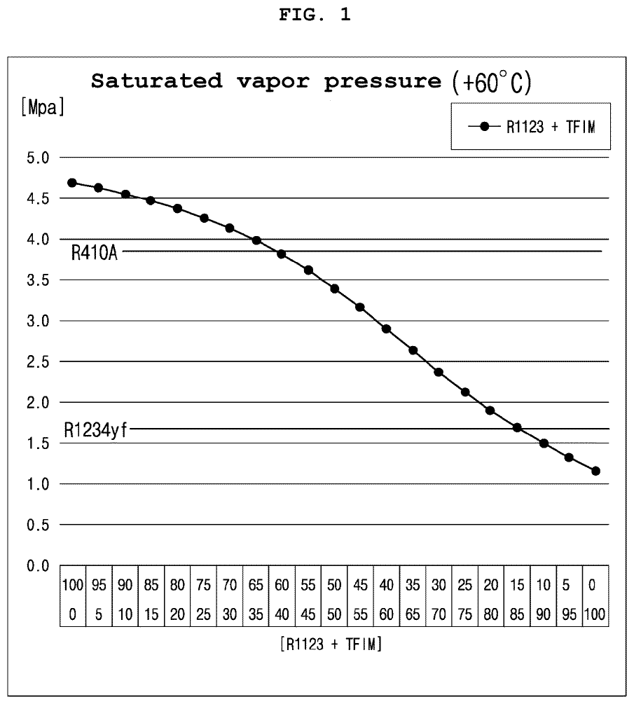

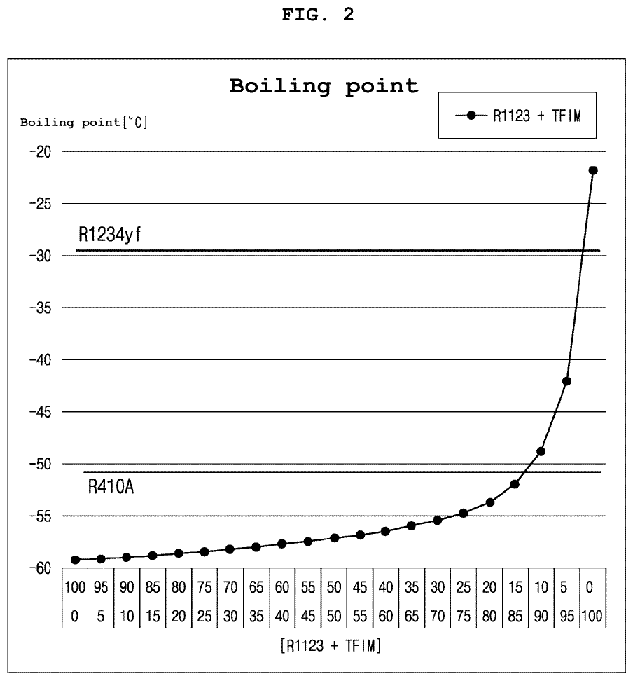

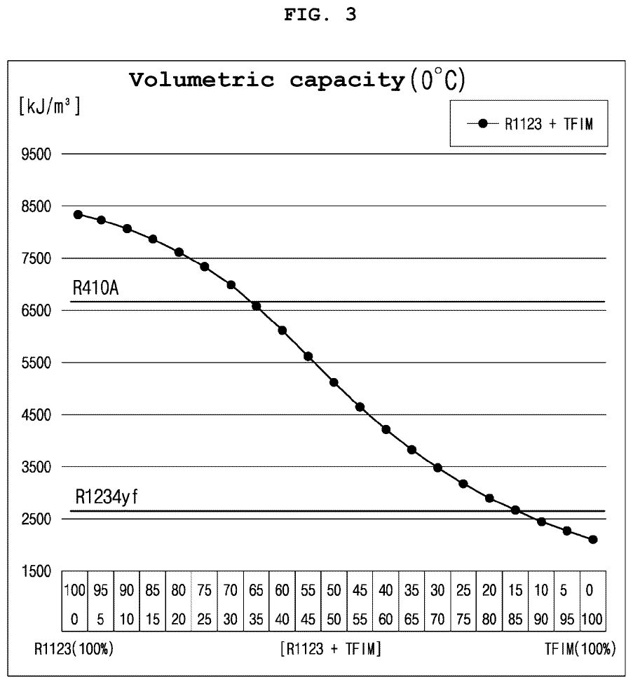

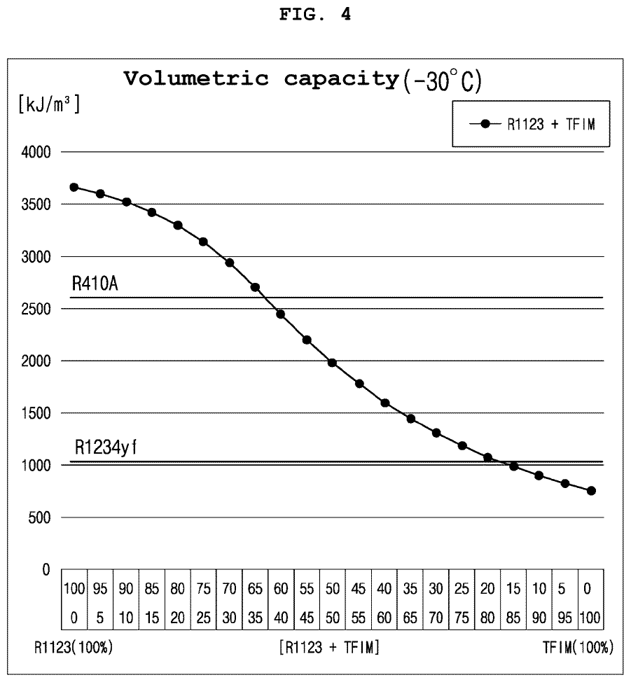

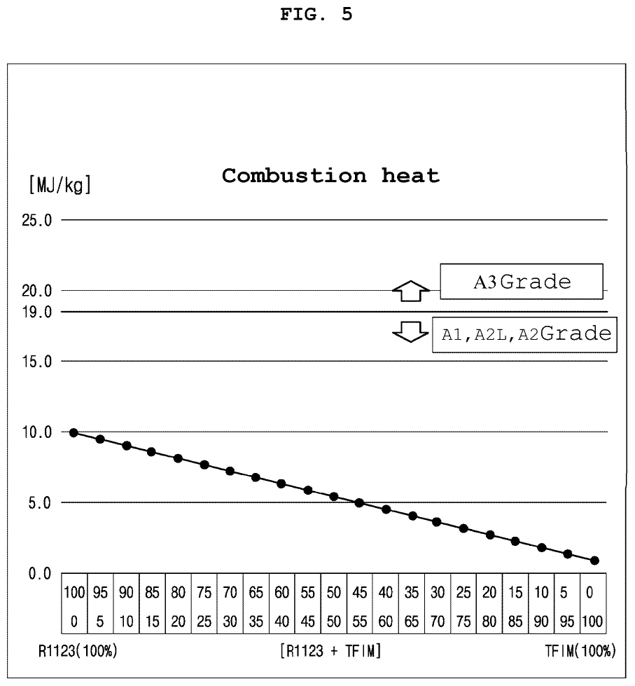

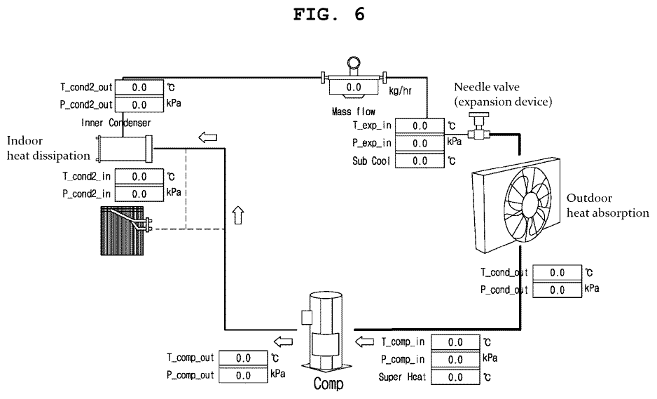

FIG. 1 is a graph showing saturated vapor pressures according to mixing ratios of trifluoroethene (R1123) and trifluoroiodomethane (R13I1) forming a refrigerant composition for an air conditioning device of the present invention, FIG. 2 is a graph showing boiling points according to the mixing ratio of trifluoroethene (R1123) and trifluoroiodomethane (R13I1) forming the refrigerant composition for an air conditioning device of the present invention, FIG. 3 is a graph showing volumetric capacities at 0° C. according to the mixing ratio of trifluoroethene (R1123) and trifluoroiodomethane (R13I1) forming the refrigerant composition for an air conditioning device of the present invention, FIG. 4 is a graph showing volumetric capacities at −30° C. according to the mixing ratio of trifluoroethene (R1123) and trifluoroiodomethane (R13I1) forming the refrigerant composition for an air conditioning device of the present invention, FIG. 5 is a graph showing combustion heat values according to the mixing ratio of trifluoroethene (R1123) and trifluoroiodomethane (R13I1) forming the refrigerant composition for an air conditioning device of the present invention, and FIG. 6 is an example of an air conditioning device tested with the refrigerant composition for the air conditioning device according to the present invention.

The refrigerant composition of the present invention includes trifluoroethene (C₂F₃H or R1123) and trifluoroiodomethane (TFIM) (CF₃I or R13I1).

The refrigerant composition of the present invention contains trifluoroethene (R1123) in the range of 25 to 35 wt %, and trifluoroiodomethane (R13I1) in the range of 65 to 75 wt %. The refrigerant composition contains 30 wt % of trifluoroethene (R1123) and 70 wt % of trifluoroiodomethane (R13I1). The trifluoroethene (R1123) is mixed in the range of 25 to 35 wt % and the trifluoroiodomethane (R13I1) is mixed in the range of 65 to 75 wt %, and a small amount (2 wt % or less based on 100 parts by weight of the R1123/R1311 mixture) of propane (R290) or R32 may be added.

The refrigerant containing the refrigerant composition according to the present invention may further include additives such as a lubricant.

Table 1 shows physical properties of trifluoroethene (R1123) and trifluoroiodomethane (R13I1).

TABLE 1
Physical properties of trifluoroethene (R1123)
and trifluoroiodomethane (R13I1)

| | Trifluoroethene | Trifluoroiodomethane |
|---|---|---|
| Item | (R1123) | (R13I1) |
| Molecular weight | 82 | 195.9 |
| (g/mol) | | |
| Boiling point (° C.) | −59.1 | −21.9 |
| Vapor pressure | 4.7 | 1.2 |
| (@60° C., MPa) | | |
| LFL (vol %) | 10 | — |
| Combustion heat | 9.9 | 0.9 |
| (MJ/kg) | | |
| Burning velocity | 6.6 | — |
| (cm/s) | | |
| Flammability | A2L | A1 |
| classification | | |
| Global warming | 1 | 1 |
| potential (GWP) | | |
| Ozone depletion | 0 | 0 |
| potential (ODP) | | |

### (LFL: Lower Flammability Limit)

Hereinafter, the refrigerant composition of the present invention will be described in more detail with reference to exemplary embodiments, which are provided only for illustrative purposes and do not limit the scope of the present invention.

The refrigerant composition according to an embodiment of the present invention contains 30 wt % of trifluoroethene (R1123) and 70 wt % of trifluoroiodomethane (R13I1) (hereinafter, referred to as “refrigerant composition embodiment of the present invention”), and is compared with R410A, R1234yf, and R134a.

The trifluoroethene (R1123) and the trifluoroiodomethane (R13I1) which form the refrigerant composition of the present invention retain their properties without significant changes even though being mixed at a predetermined ratio, and maintain environmental friendliness as a nonazeotropic composition with complementary characteristics.

Table 2 shows comparison results that boiling point, saturated vapor pressure, flammability classification, global warming potential (GWP), and ozone depletion potential (ODP) values of the refrigerant composition embodiment of the present invention are compared with those of R410A, R1234yf, and R134a.

TABLE 2
Comparison of physical properties

| Division | R410A | R1234yf | R134a | Embodiment |
|---|---|---|---|---|
| Molecular | 72.6 | 114 | 102 | 138 |
| weight (g/mol) | | | | |
| Boiling point | −51.4 | −29.5 | −26.1 | −55 |
| (° C.) | | | | |
| Saturated | 3.8 | 1.6 | 1.7 | 2.4 |
| vapor pressure | | | | |
| (@60° C., MPa) | | | | |
| Flammability | A1 | A2L | A1 | A1 |
| classification | | | | |
| Global warming | 2,088 | 4 | 1,430 | 1 |
| potential (GWP) | | | | |
| Ozone depletion | 0 | 0 | 0 | 0 |
| potential (ODP) | | | | |

As illustrated in FIG. 1, when examining the saturated vapor pressure at 60° C., the saturated vapor pressure of the refrigerant composition embodiment according to the present invention is 2.4 MPa, while R410A shows 3.8 MPa, R1234yf shows 1.6 MPa, and R134a shows 1.7 MPa. Therefore, it can be seen that the embodiment has a saturated vapor pressure approximately 58% lower than that of R410A, and about 50% higher than that of R1234yf and R134a. As shown in the boiling point graph of FIG. 2, the boiling point of the refrigerant composition according to the embodiment of the present invention is −55° C., while R410A shows −51.4° C., R1234yf shows −29.5° C., and R134a shows −26.1° C. It can be seen that the boiling point of the embodiment is 3.6° C. lower than R410A, 25.5° C. lower than R1234yf, and 28.9° C. lower than R134a.

The safety of the refrigerant composition according to the embodiment of the present invention will be examined.

According to the Refrigerants Safety Classification (ISO 817), non-toxic refrigerants are classified into A1, A2L, A2 groups, and A3 grade based on when the combustion heat is 19 MJ/kg. The refrigerant composition of the present invention corresponds to A1 grade in terms of combustion heat, as it is equal to or less than 19 MJ/kg, as shown in the combustion heat graph of FIG. 5.

In addition, the A2L standard in ASHRAE 34 is defined as a burning velocity of 10 cm/s or less. As shown in Table 1, the burning velocity of R1123 (100%) is 6.6 cm/s, and the burning velocity of R13I1 (100%) corresponds to A1. Therefore, the burning velocity of the refrigerant composition according to the embodiment of the present invention is 10 cm/s or less, and the safety grade is A1.

As can be seen from Table 2, the refrigerant composition according to the embodiment of the present invention can be used as a refrigerant, and has a significantly lower global warming potential (GWP) of 1 compared to R410A, R1234yf, and R134a, and an ozone depletion potential (ODP) of 0, being environmentally friendly.

Hereinafter, in order to confirm whether the refrigerant composition of the present invention [R1123 (30 wt %)+R1311 (70 wt %)] can be used as a substitute for R410A, R1234yf, and R134a refrigerants, a comparative experiment between the refrigerant of the present invention and R134a was conducted to verify how much the heating performance is improved. Under cold region conditions at an outdoor temperature of −15° C., experiments on heating performance, compressor power consumption, air discharge temperature, refrigerant pressure, and flow rate characteristics were conducted, and the results are shown in Tables 3 to 5 below.

When the refrigerant of the present invention is applied, it is possible to secure refrigerant pressure and flow rate without the use of an electric heater, which is used to compensate for the lack of heating performance of R134a and R1234yf. Therefore, when the refrigerant of the present invention is applied, it is possible to secure heating performance independently.

Accordingly, the refrigerant composition according to the present invention can exhibit effectiveness in xEV (BEV, PHEV) heat pump systems in the automotive field.

In addition, the refrigerant of the present invention can be used as as a substitute for R410A, and can be widely applied from small to large capacities of commercial or residential VRF system air conditioners currently using R32 as a substitute for R410A since the refrigerant of the present invention is non-flammable with A1 grade.

TABLE 3
Comparison results of heating capacity and power consumption

| | Heating capacity (kW) | Power consumption (kW) |
|---|---|---|
| R134a | 2.2 | 1.0 |
| Embodiment | 4.7 | 3.3 |

The above table shows the results based on the same compressor rpm under cold region conditions (outdoor temperature −15° C.).

TABLE 4
Comparison of heating air ejection temperature

| | Heating air ejection | Heating air ejection |
|---|---|---|
| | temp (300 m³/h) | temp (200 m³/h) |
| R134a | 4.3° C. | 13.1° C. |
| Embodiment | 25.4° C. | 42.0° C. |

The above table shows the results based on the same compressor rpm under cold region conditions (outdoor temperature −15° C.).

TABLE 4
Cycle Refrigerant Characteristics under Heating Conditions

| | R134a | Embodiment |
|---|---|---|
| High Pressure of Refrigerant (kPa) | 455 | 1,873 |
| Low Pressure of Refrigerant (kPa) | 110 | 244 |
| Refrigerant Flow Rate (kg/h) | 19 | 104 |

The above table shows the results based on the same compressor rpm under cold region conditions (outdoor temperature −15° C.). The refrigerant composition of the present invention [R1123 (30 wt %)+R13I1 (70 wt %)] has lower condensation and evaporation pressure compared to R410A, and higher than R1234yf and R134a.

In addition, the refrigerant composition of the present invention also has a significantly lower global warming potential (GWP), which is 1, compared to R410A whose GWP is 2,088 and R134a whose GWP is 1, 430, and has an ozone depletion potential (ODP) of 0, being environmentally friendly.

Therefore, the refrigerant composition of the present invention can be used as an alternative to R410A and R32, is environmentally friendly and easily applicable to existing R410A and R32 systems, and is suitable for variable refrigerant flow (VRF) systems.

The refrigerant composition of the present invention also significantly improves heating performance compared to R1234yf and R134a used in electric vehicles, thus extending winter driving range. Additionally, the refrigerant composition of the present invention is easy to manufacture as being a two-component blend refrigerant.

### INDUSTRIAL APPLICABILITY

The refrigerant composition for an air conditioning device according to the present invention has excellent heating performance and a sufficiently low global warming potential (GWP), and is non-flammable and non-toxic (A1 class) in accordance with ASHRAE standards, has the ozone depletion potential (ODP) of zero, is easy to manufacture, and can be substituted with R410A, R1234yf, and R134a through minimal modification in expansion devices and heat exchangers used in air conditioning devices. In the case of application to electric vehicles, the refrigerant composition is also expected to have an additional fire suppression effect in the event of a fire.

1. A refrigerant composition for an air conditioning device consisting of trifluoroethene (R1123) and trifluoroiodomethane (R13I1).

2. The refrigerant composition according to claim 1, wherein the trifluoroethene (R1123) is in the range of 25 to 35 wt %, and the trifluoroiodomethane (R13I1) is in the range of 65 to 75 wt %.

3. The refrigerant composition according to claim 1, wherein the trifluoroethene (R1123) is in the range of 25 to 35 wt %, and the trifluoroiodomethane (R13I1) is in the range of 65 to 75 wt %, and a small amount of propane (R290) or R32 is added.

4. The refrigerant composition according to claim 1, wherein the trifluoroethene (R1123) is 30 wt %, and the trifluoroiodomethane (R13I1) is 70 wt %.
